(19) United States
(12) Patent Application Publication
(10) Pub. No.: US 2009/0321439 A1
(43) Pub. Date: Dec. 31, 2009

(54) EXPLOSION INHIBITING MATERIAL AND METHOD OF MANUFACTURE

(75) Inventors: Charles J CEPAK, Alexandria, VA (US); Gustav JOBSTMANN, (US)

Correspondence Address: MCNEES WALLACE & NURICK LLC, 100 PINE STREET, P.O. BOX 1166, HARRISBURG, PA, 17108-1166, US

(73) Assignee: BATGA LLC, Mechanicsburg, PA (US)

(21) Appl. No.: 12/145,582

(22) Filed: Jun. 25, 2008

(51) Int. Cl. B60K 15/00

(52) U.S. Cl. 220/62.17

(57) ABSTRACT

A filling material formed into a device for inhibiting an explosion of a fuel container includes an expanded metal sheet being perforated with evenly spaced slits extending parallel in longitudinal direction of the bank and stretched transversely to the longitudinal extension to form openings in the sheet.

### FIELD OF THE INVENTION

The present invention relates generally to a filling material. More specifically, the present invention relates to a filling material that can be placed into a fuel tank for explosion inhibition and prevention.

### BACKGROUND OF THE INVENTION

Filling materials of the type involved here, are generally made from a web-like sheet material of dimensionally stable flexible material, especially metals. The sheet material is typically perforated with evenly spaced slits in parallel relation to the longitudinal extension and stretched transversely across the sheet web, and the perforated web or sheet is then placed inside a fuel container or tank.

It is known to provide the cuts in a flat sheet web in longitudinal direction of the sheet web, and then the sheet web is stretched in this flat form transversely to the longitudinal extension. As a result, only a slight deformation from the web plane is implemented. It has been shown that as a consequence of the slight deformation out of the web plane, when the sheets are placed in containers, the individual layers of the sheets bake together in the containers or interlock through movement, thereby creating free spaces within the container in which combustible liquid is present without the respective sheet inlays. As a consequence, explosive combustion may occur.

It would therefore be desirable and advantageous to provide an improved filling material to obviate prior art shortcomings, and to provide a method of and arrangement for making such a filling material.

### SUMMARY OF THE INVENTION

The present invention provides for a filling material made from a web-like sheet which is perforated with evenly spaced slits, extending parallel in the direction of the longitudinal axis, and profiled transversely to the longitudinal axis.

The profiling of the sheet transversely to the longitudinal extension is maintained during stretching so that the deformation out of the sheet plane is effected in addition to the profiling during stretching, resulting, on the one hand, in a higher elevation out of the web area and, on the other hand, a more stable deformation transversely to the web area.

According to another feature of the present invention, the profile of the sheet may be formed by undulations extending preferably across the entire sheet width so as to realize a simple continuously producible profiling. An even greater strength of the sheet transversely to the sheet plane can be realized when providing the wavy profile with edged transitions.

According to another aspect of the present invention, a filling material of the above-stated type can be made by a method in which a web or sheet of metal, especially stainless steel, is provided with evenly spaced slits in parallel relation to one another and to the longitudinal extension of the sheet, subsequently formed with an undulated profile, and thereafter stretched transversely to the longitudinal direction, thereby realizing a filling material which has been profiled in a superior way.

According to still another aspect of the present invention, an arrangement for carrying out the above-stated method includes a conveyor for transporting the sheet, a cutting tool for formation of intermittent slits in the sheet, a device for stretching the slitted sheet, with the device having a clamping unit for the longitudinal edges of the sheet and an ascending contact body, and a profiling unit, positioned upstream of the stretching device, for providing the slitted sheet with an undulated profile. Such an arrangement is simple in structure and permits a continuous fabrication of such a filling material.

According to another feature of the present invention, the profiling unit is formed by a pair of interlocking profiling drums so that a profile is realized by rolling tools which permit a high processing speed. A reliable transport and also clamping of the edge of the sheet web in the clamping unit can be realized when the profile provided in the sheets by the profiling drums corresponds to the profile of the clamping unit for the longitudinal edges of the sheet. Hereby, the profile of the clamping unit may be provided at the margins of two clamping wheels which are embraced at their profiled peripheral surfaces over a portion of the circumference by respective clamping belts. The profiling unit thus also realizes a continuous uniform advance of the sheet. The same purpose and a high advance speed can be realized by arranging the center of both clamping wheels eccentric to the center of a rotating stretching body, whereby a maximum eccentricity is established in the area of the portion of the clamping wheels embraced by the clamping belt. In this manner, it is possible to omit lubrication of the material during its passage through the arrangement. This is especially relevant when the filling material is subject to further processing, e.g., by lacquer or other coats.

According to a variation, the clamping belt may be configured as a flat belt which bears upon the outer peripheral surfaces of radially outwardly directed projections of the clamping wheels profiled at their circumferential surfaces. This has the advantage that clamping of the sheet margins does not occur over the entire length but only along portions, so as to implement a stretching action in the area of the clamped regions entirely up to the margins, whereas those areas which are located between the clamped regions are subject to less stretching so that the sheet margin moves inwardly in an undulated manner. This is advantageous when introducing into the container bundles of stretched sheet material, bearing upon one another at their flat side regions, so that the bundles interlock and are hindered from shifting relative to one another as a consequence of the uneven surface.

According to another feature of the present invention, the clamping belt may be configured as profiled belt with a profile directed outwards and complementing the profile of the clamping wheels so that the sheet margins are held over their entire length in such a manner that as a consequence of the pre-profiling of the sheet web the profile engages like a gear in the outer profile of the clamping wheels and is held in this position by the toothed belt. In the area of maximum eccentricity, the spacing between the circumference of the stretching body and the clamping unit can hereby be greater than half the width of the stretched sheet material so that the sheet margins are pulled out between the clamping parts in the clamped region, thereby ensuring that the stretching of the sheet is effected up to the edge zone so that marginal regions do not remain unstretched as experienced in conventional constructions.

The rotating stretching body may be supported for free rotation, and thus solely moved by the sheet drawn above it so that relative speeds between the sheet and the stretching body are avoided and the sheet rolls off in the desired stretching over the rotating stretching body. In addition, the rotating stretching body may itself be supported eccentrically to thereby establish an even greater irregularity.

According to another feature of the present invention, a stainless steel explosion prevention product for containers containing explosive material, such as fuel tanks, is configured from a web-like sheet of 321 annealed steel with a gauge thickness of between about 0.0001 inches and about 0.005 inches, and more particularly about 0.0015 inches, that is capable of being heated to 1500 degrees Centigrade without melting. The sheet is formed into a three-dimensional shape, such as a sphere or cylinder that has diameter of between about 0.5 inches to about 3 inches and a packing density between about 1.0% and about 1.7% per gallon volume of the fuel tank. Alternatively, the steel sheet is formed into a batted configuration having a packing density between about 0.8 to about 1.3% per gallon of volume of the fuel tank. The explosion prevention product is inserted into the container. Either formation is compressible and expandable to at least partially fill the fuel tank.

According to another feature of the invention, a stainless steel explosion prevention product for fuel tanks is made from a web-like sheet of 321 annealed steel with a gauge thickness of between about 0.0001 inches and about 0.005 inches, and more particularly about 0.0015 inches, that is capable of being heated to 1500° C. without melting. The sheet is formed into a three-dimensional shape and inserted into the fuel tank. The shape is compressible and expandable to at least partially fill the fuel tank. The steel sheet is formed into a cylinder with a diameter between about 0.5 inches to about 3 inches with a packing density between about 1.0 to about 1.7% per gallon of volume of the fuel tank.

According to another aspect of the present invention, an explosion prevention device is made by cutting in a web-like sheet of evenly spaced slits in parallel relation to one another and oriented in a longitudinal extension of the sheet. The profile of the sheet is then provided with undulations followed by stretching the sheet transversely to the longitudinal extension. The sheet is then configured to a desired shape.

According to yet another aspect of the invention, an explosion in a container containing explosive material is prevented by cutting in a web-like sheet evenly spaced slits in parallel relation to one another and oriented in a longitudinal extension of the sheet, undulating the profile of the sheet; stretching the sheet transversely to the longitudinal extension; shaping the sheet into a desired configuration; and inserting the sheet into a vessel, with the shaped sheet expands within the vessel.

According to yet another feature of the invention, an explosion prevention device for a container having of a web-like sheet with a longitudinal axis that is perforated with evenly spaced slits that extend parallel in the direction of the longitudinal axis. The sheet is stretched transversely to the longitudinal axis and is thereby elastic and allows compression to fit in the container and allows expansion to at least partially occupy the container into a desired shape.

According to another aspect of the invention, an explosion prevention device is made by the method of cutting in a web-like sheet of evenly spaced slits in parallel relation to one another and oriented in a longitudinal extension of the sheet; providing the sheet with an undulated profile; stretching the sheet transversely to the longitudinal extension; and configuring the sheet into a desired shape.

According to another aspect of the invention, an explosion in a container is prevented by the method of cutting in a web-like sheet evenly spaced slits in parallel relation to one another and oriented in a longitudinal extension of the sheet, providing the sheet with an undulated profile; stretching the sheet transversely to the longitudinal extension; configuring the sheet into a desired shape; and inserting the sheet into a vessel, wherein the shaped sheet expands within the vessel.

Accordingly to yet another aspect of the invention, an explosion prevention device for a container has a web-like sheet with a longitudinal axis; the sheet being perforated with evenly spaced slits that extend parallel in the direction of the longitudinal axis and are stretched transversely to the longitudinal axis; wherein the sheet is elastic and allows compression to fit in the container and allows to return to the shape of the device prior to compression.

Further aspects of the method and system are disclosed herein. The features as discussed above, as well as other features and advantages of the present invention will be appreciated and understood by those skilled in the art from the following detailed description and drawings.

### BRIEF DESCRIPTION OF THE DRAWINGS

FIG. 1 illustrates a filling material according to the present invention.

FIG. 2 is a sectional view of the filling material, along the line A-A of FIG. 1.

FIG. 3 is a simplified, schematic illustration of an arrangement for making a filling material in accordance with the present invention.

FIG. 4 is a schematic illustration of a profiling and stretching station forming part of the arrangement of FIG. 3.

FIG. 5 depicts the profiling and stretching station of FIG. 4, without illustration of a sheet web.

FIG. 6 is a plain view analogous to FIG. 5, with illustration of a sheet web located.

FIGS. 7A-C depict the process of inserting the explosion prevention devices into a container.

Throughout all these Figures, same or corresponding elements are generally indicated by same reference numerals.

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

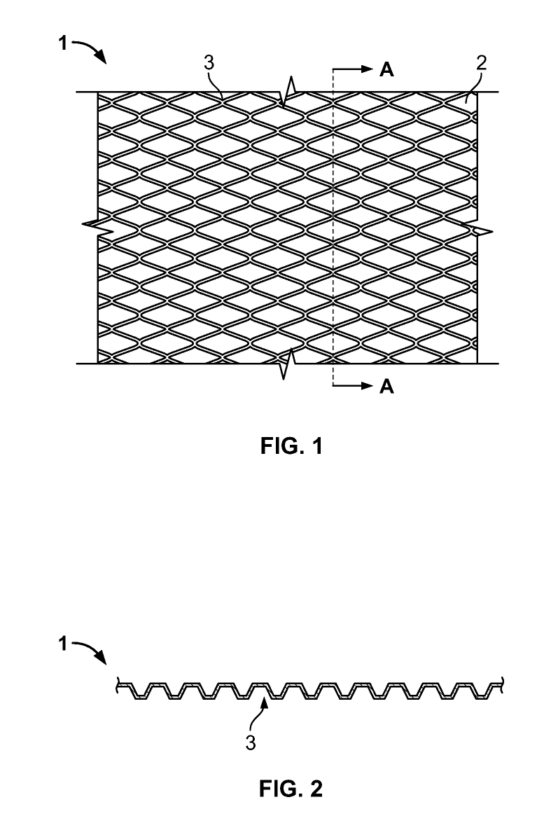

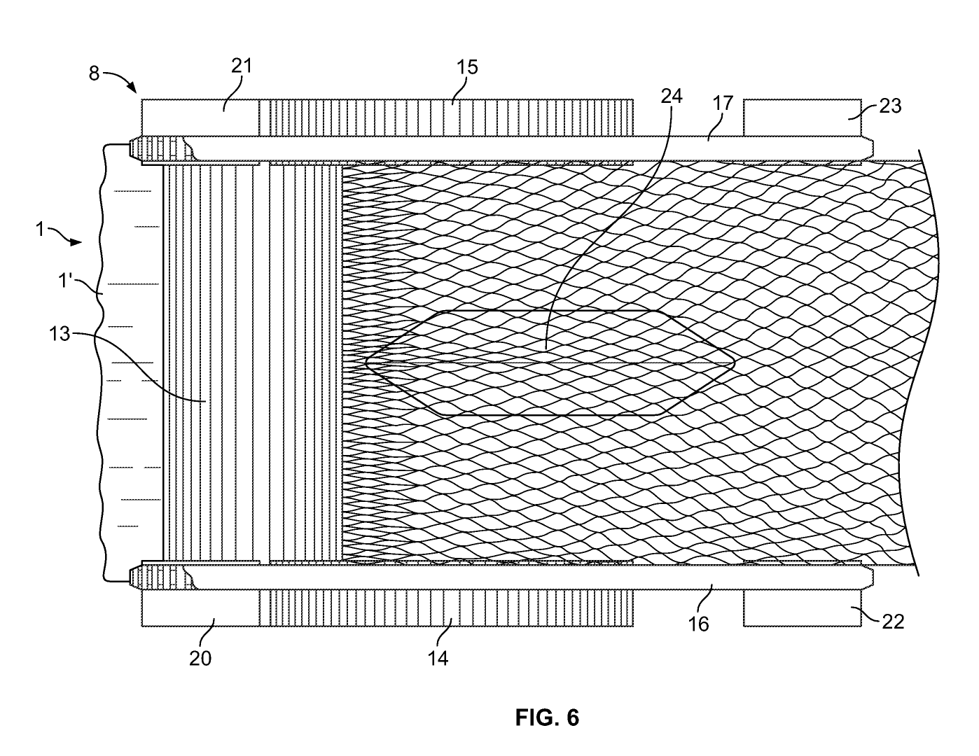

Turning now to the drawing, and in particular to FIG. 1, there is shown a plan view of a segment of a finished web-like sheet for use as filling material according to the present invention, generally designated by reference numeral 1. The sheet 1 has openings 2 which are formed through provision of slits 1′ (FIG. 6) in the sheet web and subsequent stretching, whereby the sheet 1 is profiled, as shown in FIG. 2, transversely to the longitudinal extension through undulations 3 which have edged transitions.

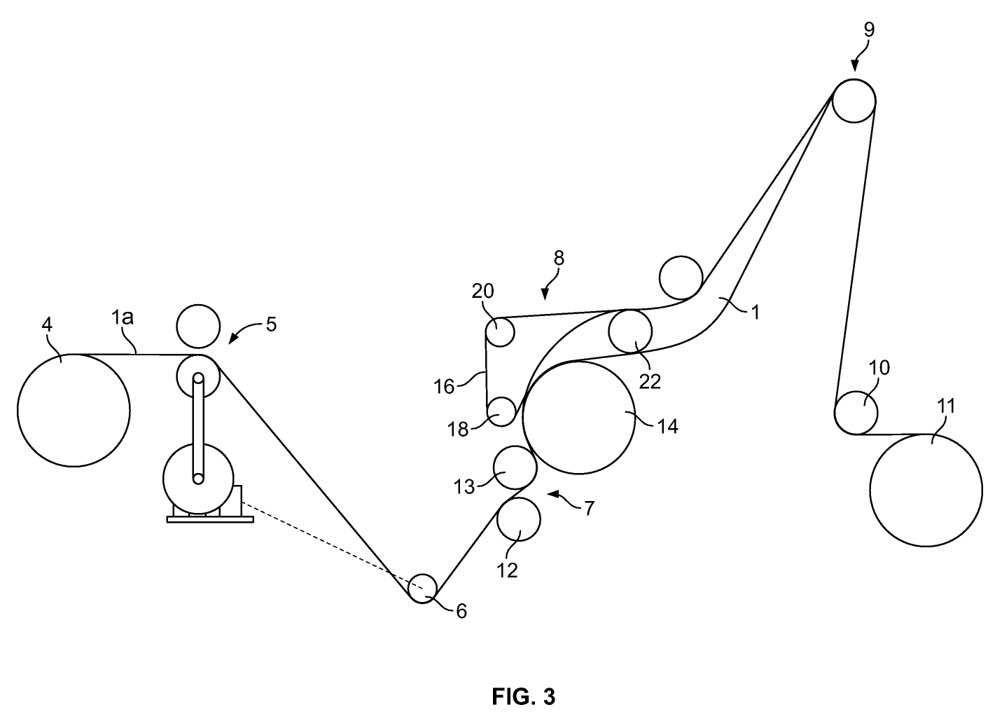

Referring to FIG. 3, there is shown a simplified, schematic illustration of an arrangement for making the finished sheet 1 in accordance with the present invention. A web 1a of sheet material, made of a steel, and more particularly, a stainless steel, is drawn from a storage roll 4 and transferred to a subsequent cutting station 5 to provide the sheet material with cuts 1′ which extend parallel to one another in longitudinal direction of the sheet web. The cuts 1′ are arranged in rows, as known in conventional constructions of this type, with each row that follows the leading row being offset laterally by half the space between the slits, so that the openings 2 are formed when the sheet web is stretched transversely just like an expanded metal. The sheet web emerging from the cutting station 5 is guided over a tension roller 6 and fed to a profiling unit 7 from which it is transferred to a stretching station 8 in which the sheet 1a is transformed to the final configuration of the sheet 1, as shown in FIG. 1. The sheet 1 is then guided via a flattening roller 9 and a tension roller 10 to a product take-up station 11.

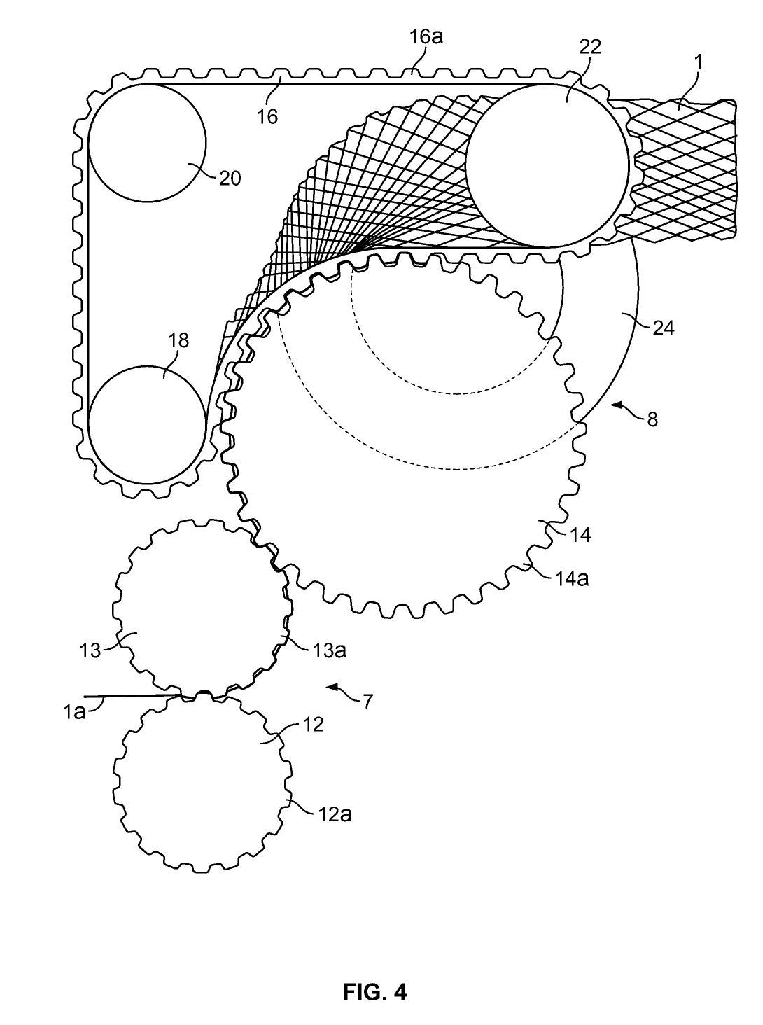

FIG. 4 shows in more detail the profiling unit 7 and the stretching station 8. The profiling unit 7 includes two profiling drums 12, 13 disposed in superimposed relationship and having an outer surface area formed with uniform longitudinal ribs 12a, 13a, with the longitudinal ribs 12a of the drum 12 engaging in the intermediate spaces between the longitudinal ribs 13a of the drum 13, so as to realize a meshing engagement of the drums 12, 13 with one another. The sheet web 1a entering the profiling unit 7 and already provided with the cuts in longitudinal direction of the sheet, is conducted between the gap between both profiling drums 12, 13 and transferred to the stretching station 8. This stretching station 8 has two clamping wheels 14, 15 (only clamping wheel 14 is visible in the illustration here) in spaced-apart disposition, with the mean spacing of both clamping wheels 14, 15 corresponding approximately to the width of the sheet emerging from the profiling unit 7. The clamping wheels 14, 15 have on their outside a profile in the form of teeth 14a which complement the ribs 12a, 13a of the profiling drums 12, 13, so that the sheet emerging from the profiling unit 7 and provided with undulations, engages directly in the teeth of the clamping wheels 14, 15. Trained over a portion of the perimeter of the clamping wheels 14, 15 are belts 16, 17 (only belt 16 is visible in the illustration here). In the non-limiting example of FIG. 4, the belts 14, 15 are configured as toothed belts, having teeth 16a (only the teeth 16a of the belt 16 are visible in the illustration here) directed outwards and engaging the teeth 14a of the clamping wheels 14, 15 such that the belts 16, 17 restrain the sheet web 1 upon the clamping wheels 14, 15.

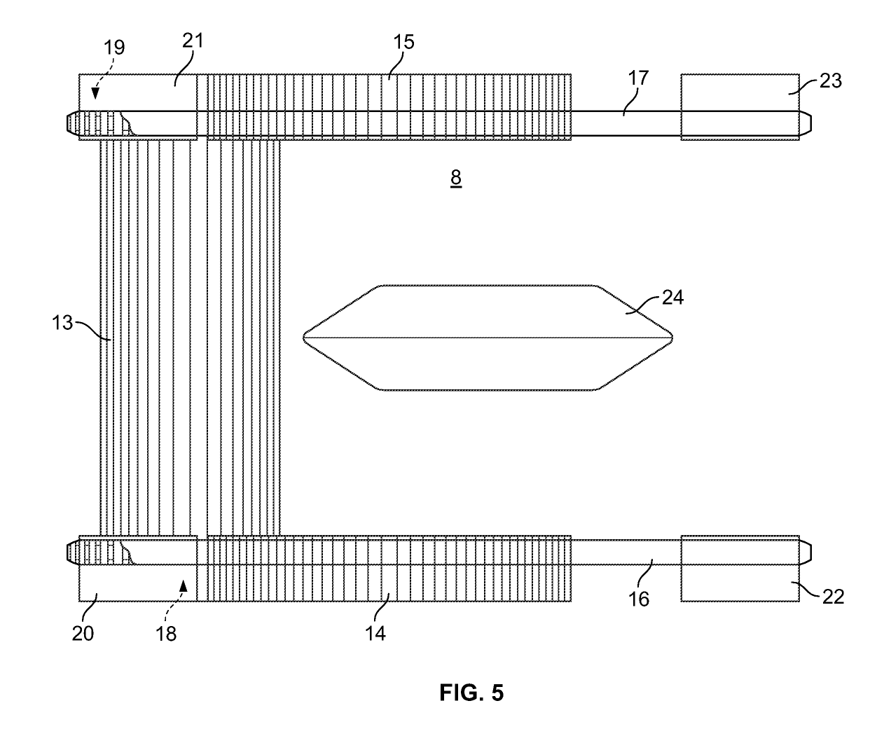

As shown in conjunction with FIG. 5, the clamping belts 16, 17 are trained over deflection rollers 18, 19, 20, 21, 22 and 23, with the contact area established by about ¼ of the circumference of the clamping wheels 14, 15. The rollers 18, 20 and 19, 21 are arranged directly above one another. This is indicated in FIG. 5 by providing the reference characters 18, 19 with dashed reference lines pointing in the direction of the rollers 20 and 21. Also indicated by FIGS. 4 and 5 is the disposition of the rollers 18, 19 directly beneath the rollers 20, 21, respectively. Disposed between the clamping wheels 14, 15 is a stretching body in the form of a freely rotatably supported stretching wheel 24, whereby the outer surface area of the stretching wheel 24 is formed by the outer surface areas of two truncated cones with adjoining bases. This formation allows a particularly good stretching in both directions, also in mid-area, without causing an excessive buckling.

As can be seen from FIG. 4, the stretching wheel 24 is supported eccentrically to the clamping wheels 14, 15, with the greatest eccentricity being arranged behind the release area of the sheet web 1 from the clamped engagement between the clamping belts 16, 17 and the clamping wheels 14, 15. The greatest distance between the outer circumference of the stretching wheel 24 and the perimeter of the clamping wheels 14, 15 is hereby greater than the width of the stretched material so that—as already set forth above—the sheet web is pulled out in transverse orientation from the clamped engagement between the clamping wheels 14, 15 and the clamping belts 16, 17 so that the stretching action is realized up to the outermost edge area of the sheet web 1.

FIG. 6 shows the manner in which the sheet web 1 is altered by the stretching action. The sheet web 1 with its slits 1′, introduced before manipulation by the profiling unit 7 between the profiling drums 12, 13, is already pre-stretched during ascension via the stretching wheel 24, whereby stretching and release are clearly recognizable by the increasingly widening openings 2. In the drawing, the clamping belts 16, 17 are shown in the form of toothed belts. Of course, other configurations are suitable as well, e.g., the configuration of the clamping belts as flat belts which thus bear only upon the outer surfaces of the outwardly projecting profiles of the clamping wheels 14, 15 so that a clamped engagement occurs locally only there and the sheet web 1 is not retained in the area of the indentations between the projections of the clamping wheels 14, 15. This results in a more pronounced stretching in the area of contact upon the outer surfaces of the projections than between the projections, so that the outer margin of the sheet web is slightly undulated. Although also not shown in the drawing in detail, the rotating stretching body 24 may itself be support eccentrically, thereby further increasing the irregularities of the stretching and realizing a undulated edge which has a greater length of undulation than the undulation as a result of the use of the flat belt.

An explosion prevention device made from the material described above will now be described. The explosion prevention product of the present invention prevents fuel tanks with volatile liquids and gases from exploding due to various causes of ignition, including sparking; electrostatic discharge; over-heating; maintenance error, etc. Fuel tanks equipped with the explosion prevention device of the present invention will not explode and will maintain their mechanical structure. The explosion prevention device is a matrix of stainless steel foil, lit and expanded to form a mesh of multi-sided shaped openings. When layered, the mesh results in an open-celled batt, which can be cut to sizes and shapes to fit any fuel tank. The device is made of non-magnetic stainless steel with a thickness range (gauge) of about 0.0001 inch to about 0.005 inch, excellent elasticity/compression capabilities and bacterial/fungus growth deterrent properties. For weight critical applications, titanium can be used. The explosion prevention product may also be characterized as a passive system, requiring no logistic or maintenance efforts once installed, thereby reducing the cost of operations.

The explosion prevention device prevents destructive pressures from being generated if vapors or gases in the ullage space ignite. These pressures arise when heat is released by rapid self-sustained burning. While appearing to be instantaneous, this burning reaction in fact takes measurable time and its progression can be recorded and analyzed. The explosion prevention device prevents destructive overpressures from rupturing a fuel tank when a ballistic threat is shot into the liquid fluid level. As a ballistic threat travels through the liquid the hydrodynamic ram effect (pressure build up) is quenched and dissipated by the device. Overpressures, in comparison to baseline unprotected tanks are greatly reduced with the claimed explosion prevention device so as to not create a ruptured/filed fuel tank. Various mechanisms may be introduced to moderate the reaction and therefore prevent an explosion. This reaction may be “quenched” buy dividing the container into minute cells, which inhibit flame propagation. In addition, the heat released during the reaction may be absorbed by a porous filler mass of high heat absorption. The layered, cellular structure of the filler mass has a high specific surface area per unit volume and excellent heat absorption capacity. These qualities work together to partially quench rapid burning and absorb almost all of the heat released by the modified reaction. The amount remaining in the partially burned gases is small and the pressure rise is drastically reduced to the point where the container's integrity can be maintained.

The explosion prevention device protects against the devastating effect of fuel explosion resulting from incendiary and other ballistic threats. The explosion prevention device is typically formed of a metal sheet, for example stainless steel or titanium metal sheet. The stainless steel used can be formed in any conventional process, including annealing, and can be of any grade desired. The stainless steel is of any workable gauge, but is typically between 0.0001 to 0.005 inches in thickness. Titanium may also be of this thickness. The material can be formed into any desired shape and, due to its elastic, accordion-type property, can be compressed as required to be inserted into a fuel tank or other container. Once inserted, the material will expand or decompress back to its original form and at least partially occupy the container. The formed shapes can include: ball/sphere, sheet, cylinder, cone, batting, or other multi-dimensional shape. The material is capable of being heated to a maximum temperature of approximately 1500° C. without the material losing its configuration; i.e., without the material melting. The material is capable of operating with all fuel types, including all liquids and gases. In addition, the material reduces liquid “slosh and surge”. Once inside the fuel tank, the material acts as a baffle and prevents rapid liquid movement and dangerous shifts in the center of gravity of the liquid, especially in bulk transport operations. The explosion prevention device also allows electrostatic charge dissipation as the metal structure provides a grounded matrix throughout the container interior. In addition, since the device is 100% recyclable, disposal requires no special facility or environment accommodations.

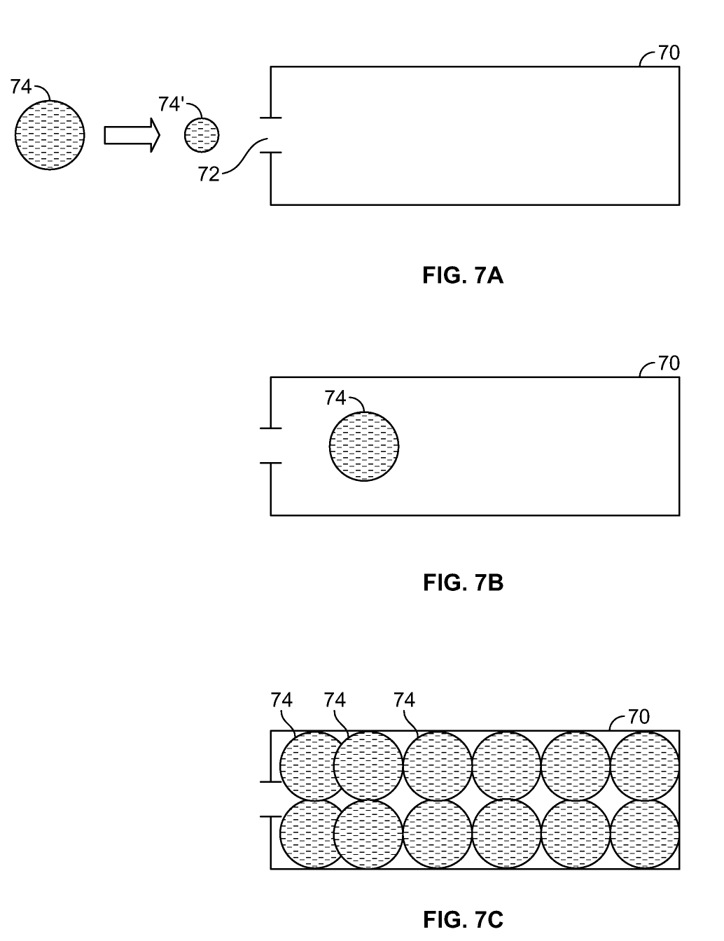

In one embodiment, for example, the metal is a stainless steel explosion prevention product for fuel tanks formed into a web-like sheet 1 as shown in FIG. 1 and may be manufactured by the previously discussed method and arrangement. The steel sheet 1 is 321 annealed steel with a gauge thickness of 0.0015 inches. If desired, the steel sheet 1 is formed into a batted configuration by layering or rolling the material to a fill/packing density between 0.8 to 1.3% per gallon of fuel tank volume. This fill/packing density is reflected in FIG. 7C, as discussed below, as the compressibility of the stainless steel allows for occupation of void space. If desired, the steel sheet 1 is formed into a sphere or cylinder with a diameter between 0.5 inches to 3 inches with a fill/packing density between 1.0 to 1.7% per gallon of fuel tank volume. The steel sheet 1 can sustain 1500 degrees Centigrade before melting and can operate to prevent explosion of either a liquid or a gas.

The method of preventing the explosion of a container containing explosive material will not be described. Referring to FIG. 7A, a fuel tank 70 that does or will contain flammable, explosive material is shown. The filling material sheet 1 manufactured by the inventive process discussed above with regard to FIGS. 1-6 and shaped, in this example, as a sphere 74 is inserted in the opening 72 of the fuel tank 70. The sphere 74, shown in FIG. 7A, is compressed into sphere 74′ to pass through opening 72. Once the sphere 74′ is inserted, the elastic, accordion-like properties of the filling material sheet 1 cause the sphere 74′ to expand and return to the shape of sphere 74 within the fuel tank 70, as shown in FIG. 7B. The explosive prevention device in spherical form 74 has now expanded to occupy part of the fuel tank 70. As shown in FIG. 7C, a number of spherical devices 74 are inserted into the container, depending upon the size of the container. Once all of the spherical devices 74 inserted into the container have expanded, the spherical devices 74 made of filling material 1 prevent explosions of the fuel tank 70 as discussed above. Although the fuel tank 70 of FIG. 7C is shown with void space, the compressibility of the spheres allows occupation of the void space once the appropriate number of spheres 74 are inserted.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A filler material for inhibiting an explosion in a fuel tank, comprising:
an expanded metal sheet having a thickness of between about 0.0001 inches and about 0.005 inches;
wherein the expanded metal sheet is formed into a three-dimensional shape.

2. The filler material of claim 1, wherein the thickness is about 0.0015 inches.

3. The filler material of claim 1, wherein the expanded sheet metal is a stainless steel.

4. The filler material of claim 1, wherein the expanded sheet material is titanium.

5. The filler material of claim 1, wherein the expanded metal sheet will not melt below 1500° C.

6. The filler material of claim 1, wherein the expanded metal sheet is formed into a batted configuration having a packing density between 0.8 to 1.3% per gallon of volume of the fuel tank.

7. The filler material of claim 1, wherein the expanded metal sheet is formed into compressible spheres having a packing density between 1.0 to 1.7% per gallon of volume of the fuel tank.

8. An explosion inhibited fuel container, comprising:
a fuel container; and
a filler material disposed within the fuel container,
wherein the filler material is formed of an expanded metal sheet having a thickness of between about 0.0001 inches and about 0.005 inches.

9. The container of claim 8, wherein the expanded metal sheet has a thickness of about 0.0015 inches.

10. The container of claim 8, wherein the three-dimensional shape substantially fills the fuel container.

11. The container of claim 8, wherein the filler material has a batted configuration having a packing density of between 0.8 to 1.3% per gallon of volume of the fuel tank.

12. The container of claim 8, wherein the filler material is formed into compressible spheres having a packing density between about 1.0 to about 1.7% per gallon of volume of the fuel tank.

13. A method of making a filler material for a fuel container, comprising:
providing a stainless steel sheet having a thickness of between about 0.0001 inches and about 0.005 inches, the stainless steel sheet having a longitudinal direction and a width;
forming cuts into the sheet that extend parallel to one another in the longitudinal direction of the stainless steel sheet;
stretching the stainless steel sheet transverse to the longitudinal direction to stretch the cuts to form openings in the stainless steel sheet and form the filler material.

14. The method of claim 14, further comprising:
inserting the filler material into a fuel container.

15. The method of claim 14, wherein the filler material is formed into a batted configuration having a packing density between 0.8 to 1.3% per gallon of volume of the fuel container.

16. The method of claim 14, wherein the filler material is formed into compressible spheres having a packing density between about 1.0 to about 1.7% per gallon of volume of the fuel container.

17. The method of claim 15, wherein the stainless steel sheet thickness is about 0.0015 inches.
